(19) United States
(12) Patent Application Publication
(10) Pub. No.: US 2026/0290041 A1
(43) Pub. Date: Sep. 24, 2026

(54) INFORMATION PROCESSING DEVICE, INFORMATION PROCESSING METHOD, AND NON-TRANSITORY STORAGE MEDIUM

(71) Applicant: HONDA MOTOR CO., LTD., Tokyo (JP)

(72) Inventors: Ryuji Iwashita, Wako-shi (JP); Seungho Choi, Wako-shi (JP); Kotaro Masuda, Wako-shi (JP); Yuji Yasui, Wako-shi (JP)

(21) Appl. No.: 19/549,175

(22) Filed: Feb. 25, 2026

(30) Foreign Application Priority Data
Mar. 24, 2025 (JP) 2025-048893

(51) Int. Cl. G06V 20/59; B60K 35/10; B60K 35/22; B60K 35/26; G06V 20/58; G06V 40/16

(52) U.S. Cl. CPC G06V 20/597; B60K 35/10; B60K 35/22; B60K 35/26; G06V 20/58; G06V 40/161; B60K 2360/178; B60K 2360/741

(57) ABSTRACT

An information processing device acquires a surroundings image of a vehicle and a driver image including a driver of the vehicle, detects a risk object present around the vehicle on the basis of the surroundings image, detects the driver’s face on the basis of the driver image, and causes a warning part to perform a warning in different modes depending on whether or not the driver’s face is detected when the risk object is detected.

### CROSS-REFERENCE TO RELATED APPLICATION

Priority is claimed on Japanese Patent Application No. 2025-048893, filed Mar. 24, 2025, the content of which is incorporated herein by reference.

### BACKGROUND

### Field of the Inventions

The present invention relates to an information processing device, an information processing method, and a non-transitory storage medium.

### Description of Related Art

In recent years, efforts to provide access to sustainable transportation systems that take into account, among transportation users, vulnerable populations such as the elderly, people with disabilities, and children have been increasingly active. To achieve this goal, in particular, attention has focused on research and development to further improve transportation safety and convenience through development of transportation methods for the elderly and people with disabilities. (Japanese Unexamined Patent Application, First Publication Nos. 2021-174436 and 2024-011505, and Japanese Patent Nos. 4604691 and 6627787)

### SUMMARY

Incidentally, there is known technology of detecting risks around a moving vehicle and warning the driver of the presence of the risks using on-screen displays, sound, or the like (see Patent Documents 1 and 2). However, in this known technology, there is a concern that, if the driver is unable to see the screen, he or she may not be able to recognize the warning displayed on the screen. On the other hand, there is another concern that constant audible warnings can be annoying to the driver and reduce driving comfort.

The present invention has been made in consideration of such circumstances, and an object thereof is to provide an information processing device, an information processing method, and a non-transitory storage medium in which appropriate warnings can be issued in accordance with a driver’s condition, thereby contributing to the development of sustainable transportation systems.

An information processing device, an information processing method, and a non-transitory storage medium according to the present invention adopt the following configurations.
(1): An information processing device according to an aspect of the present invention including a storage medium configured to store computer-readable instructions, and one or more processors connected to the storage medium, the one or more processors executing the computer-readable instructions to: acquire a surroundings image of a vehicle and a driver image including a driver of the vehicle; detect a risk object present around the vehicle on the basis of the surroundings image; detect the driver’s face on the basis of the driver image; and cause a warning part to perform a warning in different modes depending on whether or not the driver’s face is detected when the risk object is detected.
(2): In the above aspect (1), the one or more processors execute the computer-readable instructions to: acquire the surroundings images in chronological order; detect approach of the risk object to the vehicle on the basis of a plurality of the surroundings images; and cause the warning part to perform the warning in a first mode when the approach of the risk object are detected and the driver’s face is not detected.
(3): In the above aspect (1) or (2), the one or more processors execute the computer-readable instructions to determine that the driver’s face is not detected when the driver’s face is not included in the driver image.
(4): In any of the above aspects (1) to (3), the one or more processors execute the computer-readable instructions to: acquire the driver images in chronological order; detect the driver's motion on the basis of a plurality of the driver images; and determine that the driver’s face is not detected when the driver’s motion of moving from a first position to a second position is detected, the first position being detectable of the driver’s face, the second position being non detectable of the driver’s face, and the driver’s face is not included in the driver images.
(5): In the above aspect (4), the one or more processors execute the computer-readable instructions to determine that the driver’s face is not detected when the driver’s motion is a forward leaning motion of the driver and the driver’s face is not included in the driver images.
(6): In the above aspect (4), the one or more processors execute the computer-readable instructions to determine that the driver’s face is not detected when the driver’s motion is a motion of the driver turning left or right and the driver’s face is not included in the driver images,
(7): In the above aspect (4), the one or more processors execute the computer-readable instructions to determine that the driver’s face is not detected when the driver’s motion is a motion of covering the driver’s face with part of the driver’s body and the driver’s face is not included in the driver images.
(8): In any of the above aspects (1) to (3), the one or more processors execute the computer-readable instructions to cause the warning part to perform the warning in a second mode different from the first mode when the risk object are detected and the driver’s face is detected.
(9): In the above aspect (8), the one or more processors execute the computer-readable instructions to: determine whether or not there is an oversight on the risk object on the basis of information relating to the risk object and information relating to the driver image when the driver’s face is detected; and change a degree of warning performed by the warning part depending on whether or not there is an oversight on the risk object.
(10): In the above aspect (9), the one or more processors execute the computer-readable instructions to cause the warning part not to perform the warning when it is determined that there is no oversight on the risk object.
(11): In any of the above aspects (1) to (10), the first mode warning includes, at least, a warning by display and a warning by sound.
(12): In the above aspect (11), the one or more processors execute the computer-readable instructions to cause the warning part to perform the warning in the first mode when the driver’s face is not detected and a plurality of the risk object is detected.
(13): In the above aspect (9), the second mode warning is at least a warning by display.
(14): An information processing method according to an aspect of the present invention is causing a computer to execute: acquiring a surroundings image of a vehicle and a driver image including a driver of the vehicle; detecting a risk object present around the vehicle on the basis of the surroundings image; detecting the driver’s face on the basis of the driver image; and causing a warning part to perform a warning in different modes depending on whether or not the driver’s face is detected when the risk object is detected.
(15): A non-transitory storage medium storing a program according to an aspect of the present invention is causing a computer to execute: acquiring a surroundings image of a vehicle and a driver image including a driver of the vehicle; detecting risk object present around the vehicle on the basis of the surroundings image; detecting the driver’s face on the basis of the driver image; and causing a warning part to perform a warning in different modes depending on whether or not the driver’s face is detected when the risk object is detected.

According to the aspects (1) to (15), it is possible to perform appropriate warnings depending on a driver’s conditions.

### BRIEF DESCRIPTION OF DRAWINGS

FIG. 1 is a diagram showing an example of a configuration and a use environment of a driving monitoring device including an information processing device according to an embodiment.

FIG. 2 is a diagram showing an example of the driving monitoring device according to the embodiment.

FIG. 3 is a diagram showing an example of an image acquired by the driving monitoring device according to the embodiment.

FIG. 4 is a diagram showing an example of detection information detected by a detector according to the embodiment.

FIG. 5 is a diagram showing an example of a first mode warning by display performed by a warning part according to the embodiment.

FIG. 6 is a diagram showing an example of a situation to which the process of the embodiment is applied.

FIG. 7 is a diagram showing an example of a second mode warning performed by the warning part according to the embodiment.

FIG. 8 is a flowchart showing an example of a process flow executed by the information processing device.

### DETAILED DESCRIPTION

Embodiments of an information processing device, an information processing method, and a non-transitory storage medium according to the present invention will be described below with reference to the drawings. In the following, description will be made assuming that a forward direction of a vehicle is a plus X direction, a rearward direction of the vehicle is a minus X direction, a rightward direction with respect to the plus X direction, which is a width direction of the vehicle, is a plus Y direction, a leftward direction thereof is a minus Y direction, and a direction orthogonal to the X and Y directions, which is a height direction of the vehicle, is a plus Z direction.

### Overall Configuration

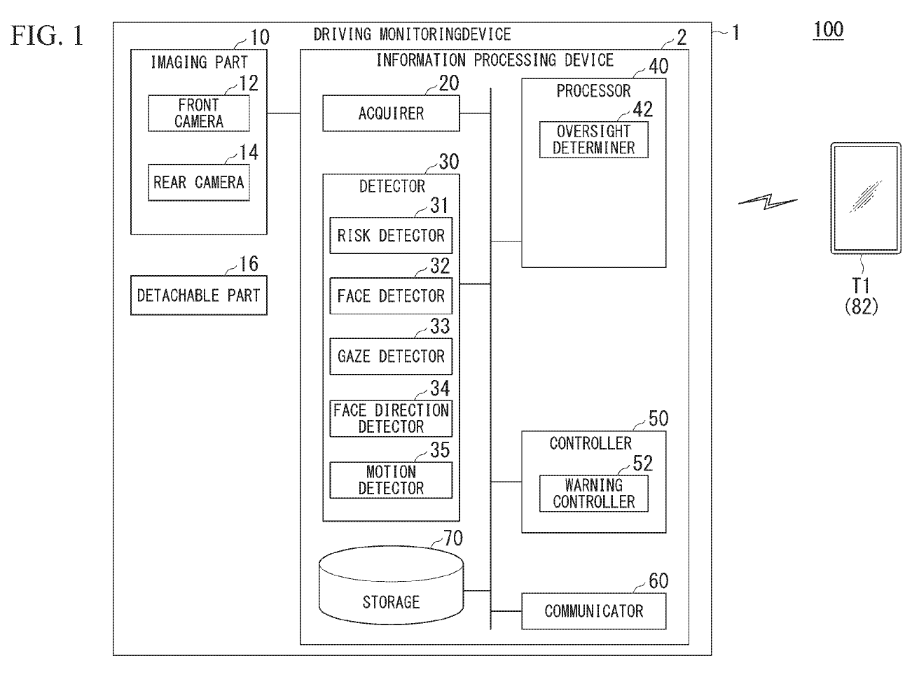

FIG. 1 is a diagram showing an example of a configuration and a use environment of a driving monitoring device 1 including an information processing device 2 according to an embodiment. The information processing device 2 is installed in the driving monitoring device 1 that is retrofitted to a vehicle (hereinafter referred to as a “vehicle M”), such as a drive recorder. That is, the driving monitoring device 1 (information processing device 2) is detachable from the vehicle M via a detachable part (hereinafter referred to as a “detachable part 16”). The information processing device 2 is, for example, a device that is not connected to an in-vehicle network of the vehicle M. The in-vehicle network is an in-vehicle network using communication standards, such as Controller Area Network (CAN), to which electronic control units (ECUs) relating to vehicle control, such as driving, braking, and steering of the vehicle M, various vehicle sensors, driving-related operators, and operating buttons, are connected. A network of the vehicle M for Human Machine Interface (HMI) may be excluded from the in-vehicle network.

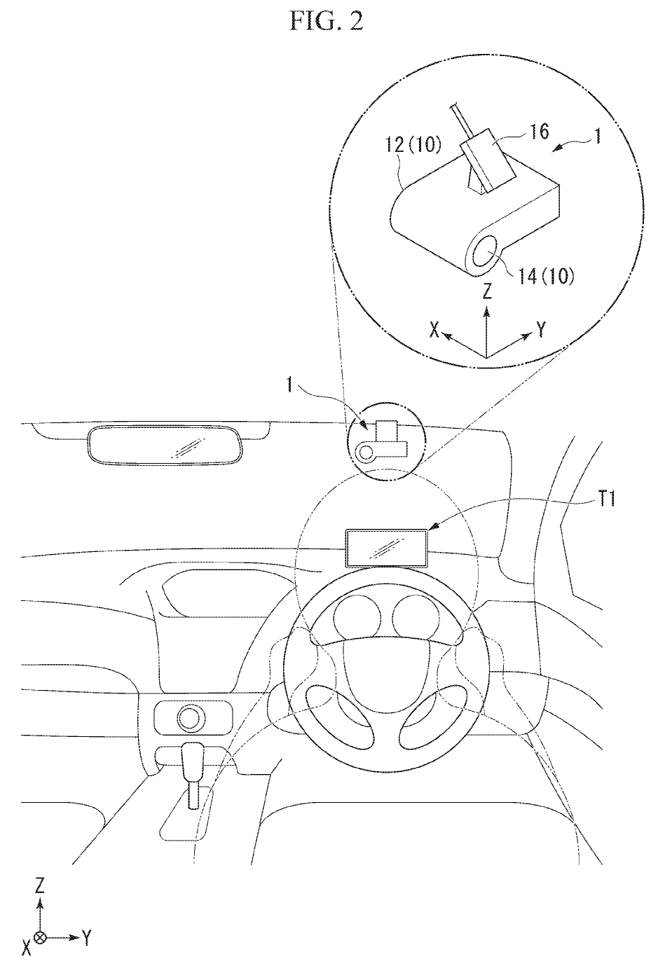

FIG. 2 is a diagram showing an example of the driving monitoring device 1. The driving monitoring device 1 is attached to a portion, for example, near a front windshield of the vehicle M and located in the vicinity of the front of a driver’s seat. The driving monitoring device 1 stores images (moving images) captured by an imaging part 10, for example, in a storage 70 (described later). The driving monitoring device 1 may have a configuration in which a display device such as a liquid crystal display (LCD) is provided and the images (moving images) stored in the storage 70 can be displayed on the display device.

The driving monitoring device 1 includes, for example, the imaging part 10, the detachable part 16, and the information processing device 2. The imaging part 10 in the shown example includes a front camera 12 and a rear camera 14.

Each of the front camera 12 and the rear camera 14 is a digital camera using, for example, a solid-state image sensor such as a charge coupled device (CCD) or a complementary metal oxide semiconductor (CMOS). The front camera 12 repeatedly (periodically) captures images of the surroundings in front of the vehicle M from a position at which the driving monitoring device 1 is attached. The rear camera 14 repeatedly (periodically) captures images of the surroundings behind the vehicle M and images of an inside of a compartment of the vehicle M from the position at which the driving monitoring device 1 is attached. A viewing angle in a horizontal direction imaged by each of the front camera 12 and the rear camera 14 is, for example, 180 degrees or more. That is, the driving monitoring device 1 (imaging part 10) captures images in the range of 360 degrees around the vehicle M from the attached position. Each of the front camera 12 and the rear camera 14 may be, for example, a fisheye camera including a fisheye lens. Alternatively, each of the front camera 12 and rear camera 14 may be a wide angle camera or the like. In the present embodiment, a case in which the front camera 12 and the rear camera 14 are used will be described, but other cameras may be used instead of or in addition to these. That is, the imaging part 10 may be configured to capture images used in the present embodiment (surroundings images and driver images, described below).

The detachable part 16 is, for example, a member for attaching the driving monitoring device 1 to the vehicle M. The detachable part 16 is any member, for example a support member or the like such as a suction cup, a seal, and a bracket. The detachable part 16 may include a power supply cable (for example, wiring) for supplying power to the driving monitoring device 1.

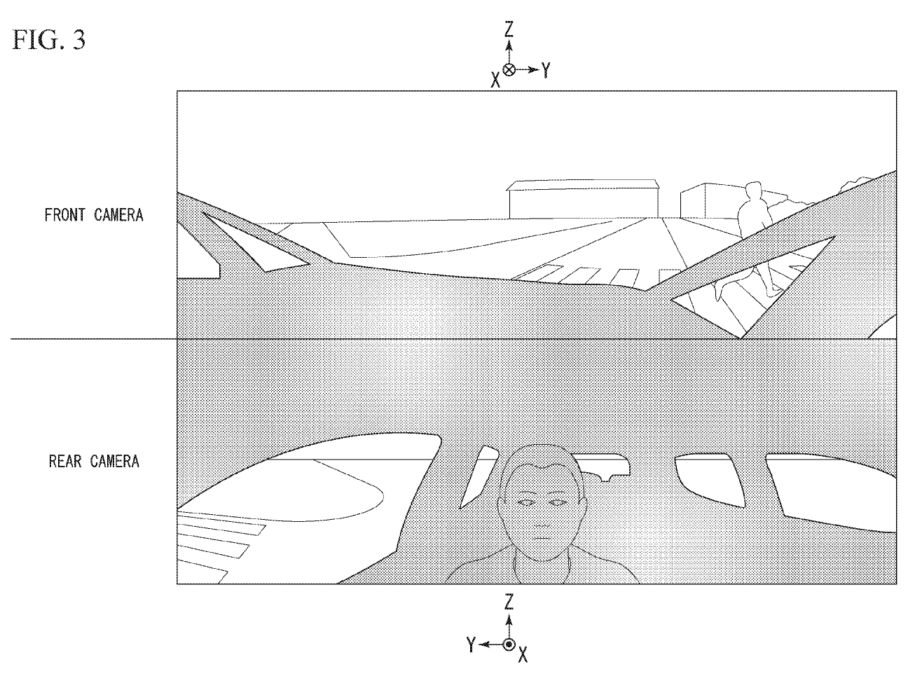

FIG. 3 is a diagram showing an example of an image acquired by the driving monitoring device 1. That is, FIG. 3 is a diagram showing an example of an image captured by the imaging part 10. The front camera 12 captures an image of a front side of the vehicle M through the front windshield, a side window on the driver’s seat side, and a side window on a passenger’s seat side. The rear camera 14 captures an image of an inside of the compartment (passengers including the driver) of the vehicle M, images behind the vehicle M through the side window on the driver’s seat side, the side window of the passenger’s seat side, and the rear window, and the like.

In the image captured by the front camera 12 (hereinafter referred to as a “front image”), for example, objects in front of the vehicle M seen through the front windshield, and on right and left sides (in front) of the vehicle M seen through the right and left side windows, such as other vehicles, pedestrians, bicycles, fixed objects, and road markings, appear as subjects.

In the image captured by the rear camera 14 (hereinafter referred to as a “rear image”), objects in the compartment of the vehicle M, behind the vehicle M seen through the rear window, and on the right and left sides of (behind) the vehicle M seen through the right and left side windows appear. For this reason, in the rear image captured by the rear camera 14, at least the driver of the vehicle M to which the driving monitoring device 1 is attached appears as a subject.

The front image and the rear image include images of the situation around the vehicle M (hereinafter referred to as “surroundings images”). The rear image includes images in which the driver of the vehicle M is captured (“driver images”). The driving monitoring device 1 may be installed in any location as long as it is a position at which the imaging part 10 can capture the surroundings images and the driver images.

The information processing device 2 (see FIG. 1) outputs warnings and notifications via a first terminal device T1 on the basis of the results of referencing the surroundings images and the driver images output by the imaging part 10. The driving monitoring device 1 and the first terminal device T1 may be collectively referred to as an “information processing system 100.”

The first terminal device T1 is, for example, a portable terminal device, such as a smartphone or a tablet terminal, which is used by the driver driving the vehicle M to which the driving monitoring device 1 is attached. In the first terminal device T1, for example, an application for receiving warnings and notifications from the information processing device 2 is being executed. The application causes a display device to display images based on information transmitted by the information processing device 2 (for example, warning information, notification information, or the like, as described below), or causes a speaker to output sound. The first terminal device T1 is also referred to as a warning part 82. The first terminal device T1 is used, for example, in a state in which it is detachably attached to the vehicle M. For example, a holder for the first terminal device T1 having the detachable part is provided on either or both of the first terminal device T1 and the vehicle M, and the first terminal device T1 is supported by the holder.

Instead of the first terminal device T1, a navigation system, a display, or a speaker of the vehicle M may be used. That is, the navigation system, the display, or the speaker of the vehicle M may output a warning or notification on the basis of an instruction from the information processing device 2. That is, the warning part 82 may be the navigation system of the vehicle M or the display or speaker of the vehicle M. Instead of the first terminal device T1, the driving monitoring device 1 may be provided with a display (warning part 82) or a speaker (warning part 82).

As shown in FIG. 1, the information processing device 2 includes, for example, an acquirer 20, a detector 30, a processor 40, a controller 50, a communicator 60, and a storage 70. The detector 30 includes a risk detector 31, a face detector 32, a gaze detector 33, a face direction detector 34, and a motion detector 35. The processor 40 includes an oversight determiner 42. The controller 50 includes a warning controller 52.

The acquirer 20, the detector 30, the processor 40, and the controller 50 each include, for example, a hardware processor such as a central processing unit (CPU) and a storage device (a storage device including a non-transitory storage medium) that stores a program (software), and functions of each constituent element are realized by the processor executing the program. Some or all of these constituent elements may be realized by hardware (a circuit part including circuitry) or the like, such as a large scale integration (LSI), an application specific integrated circuit (ASIC), a field-programmable gate array (FPGA), or a graphics processing unit (GPU), or functions of the constituent elements may be cooperatively realized by software and hardware. The functions of some or all of such constituent elements may be realized by a dedicated LSI.

The program (software) may be stored in advance in the storage 70 (a storage device including a non-transitory storage medium) included in the information processing device 2, such as a read only memory (ROM), a random access memory (RAM), or a flash memory, or may be stored in a removable storage medium (non-transitory storage medium) such as a memory card and installed in the storage device by setting the storage medium to the driving monitoring device 1. The program (software) may be downloaded in advance from another computer device through short-range communication or wide-area communication by the application executed in the first terminal device T1, and transmitted from the first terminal device T1 to be installed in the storage device.

The storage 70 stores, for example, programs (for example, the above-described program), various other types of information, and the like. The storage 70 may be realized by the various storage devices, an electrically erasable programmable read only memory (EEPROM), or the like. The communicator 60 is an interface for wireless or wired communication with an information processing device (external device) such as the first terminal device T1.

The driving monitoring device 1 (information processing device 2) performs at least a risk object warning process. The risk object warning process is a process of causing the warning part 82 to output a warning depending on the driver’s condition when a risk object is present around the vehicle M on the basis of the surroundings images and the driver images.

The risk object is, for example, an object that the vehicle M needs to avoid. The risk object is, for example, an object that will interfere with the vehicle M if it moves from its current state, or an object that has a possibility of interfering therewith. The object that has a possibility of interfering is, for example, an object whose degree of approach will reach a predetermined degree or higher after a predetermined period of time in the case of taking into account a position, a moving direction, and a moving speed of the object and a position, a moving method, and a moving speed of the vehicle M. The object may be a traffic participant such as a pedestrian, a bicycle, or a vehicle, or may be an object other than a traffic participant such as an object placed on a road or a falling object.

### Risk Object Warning Process

The acquirer 20 acquires the front image and the rear image from the imaging part 10. Thus, the acquirer 20 associates the surroundings images with the driver images and acquires them. Since the imaging part 10 repeatedly (periodically) captures the surroundings images and the driver images, the acquirer 20 repeatedly (periodically) acquires the surroundings images and the driver images. The acquirer 20 acquires the surroundings images and the driver images in chronological order. The acquirer 20 may acquire the surroundings images and the driver images by associating them to the times at which they were captured (imaged times).

The risk detector 31 detects risk objects in the surroundings images. “Detecting a risk object” indicates, for example, detecting the presence of a risk object and detecting a risk object position relative to the vehicle M (driving monitoring device 1) of the risk object (hereinafter referred to as a “risk position”). For example, reference information (not shown) indicating a relationship between the risk position in the surroundings images and its position relative to the vehicle M may be stored in the storage 70 in advance. The risk detector 31 may detect the position of the risk object relative to the vehicle M on the basis of the reference information.

By detecting the relative position of the risk object with respect to the vehicle M, the risk detector 31 also detects a direction of presence (approaching direction) of the risk object relative to the vehicle M. The “direction of presence of a risk object” indicates, for example, a direction of presence of a risk object, which approaches the vehicle M (driving monitoring device 1), with respect to the vehicle M (driving monitoring device 1). Hereafter, the “direction of presence of a risk object” may be referred to as a “risk presence direction.”

The risk detector 31 may detect approach of the risk object to the vehicle M on the basis of a plurality of surroundings images acquired in chronological order. For example, the risk detector 31 may detect approach of the risk object by detecting and comparing relative positions of the risk object with respect to the vehicle M corresponding to each of a surroundings image acquired at a first time point and a surroundings image acquired at a second time point, which is a time point earlier than the first time point. If the relative position of the risk object at the first time point is closer to the vehicle M than the relative position of the risk object at the second time point, the risk detector 31 determines that the approach of the risk object is detected. If the relative position of the risk object at the first time point is farther from the vehicle M than the relative position of the risk object at the second time point, or if the relative position of the risk object at the first time point is equal to the relative position of the risk object at the second time point, the risk detector 31 determines that the approach of the risk object is not detected.

The face detector 32 detects the driver’s face in the driver image. Specifically, the face detector 32 detects the driver’s face by analyzing the driver image using a predetermined image analysis method. In other words, the face detector 32 determines whether or not the driver’s face is detected in the driver image. If the driver’s face is detected, the driver's face is included in the driver image, and if the driver’s face is not detected, the driver’s face is not included in the driver image. If the driver’s motion is detected by the motion detector 35, which will be described later, and the driver’s face is not included in the driver image, the face detector 32 may determine that the driver’s face is not detected. If the driver’s face is not included in the driver image and the driver’s motion is not detected, the face detector 32 does not determine that the driver’s face is not detected.

The gaze detector 33 detects the driver’s gaze in the driver image. Specifically, if the driver’s face is included in the driver image, the gaze detector 33 detects the driver’s gaze by analyzing the driver image using a predetermined image analysis method. “Detecting gaze” indicates, for example, detecting positions of the driver’s eyes and their gaze direction (eye direction). If the driver’s face is included in the driver image, the gaze detector 33 detects the driver’s gaze. If the driver’s face is not included in the driver image, the gaze detector 33 does not detect the driver’s gaze.

The face direction detector 34 detects at least a direction of the driver’s face in the driver image. Specifically, if the driver’s face is included in the driver image, the face direction detector 34 detects the direction of the driver’s face by analyzing the driver image using a predetermined image analysis method. In addition to the direction of the driver’s face, the face direction detector 34 may detect a position of the driver’s face. Hereafter, information obtained by combining a “face direction” and a “face position” may be referred to as “face information.” If the driver’s face is included in the driver image, the face direction detector 34 detects the face information in the driver image. If the driver’s face is not included in the driver image, the face direction detector 34 does not detect the face information.

The motion detector 35 detects the driver’s motion on the basis of the driver image. Specifically, the motion detector 35 detects the driver’s motion on the basis of a plurality of driver images acquired in chronological order. The driver’s motion is any motion in which the driver’s face moves from a detectable position to an undetectable position. The detectable position is an example of a “the first position” as defined in the claims. The undetectable position is an example of a “the second position” as defined in the claims. The driver’s motion includes, for example, a forward leaning motion, a turning around motion, a motion of covering the face with a part of the driver’s body, and the like. The turning around motion is a motion in which the driver’s face moves to an undetectable position in the driver images as the driver turns left or right. The motion of covering the face with a part of the driver’s body may be, for example, a motion of the driver covering the face with his or her hand to block the sunlight. The motion detector 35 detects the driver’s motion by analyzing the face information detected from the plurality of driver images and information such as the driver’s contour using a predetermined method.

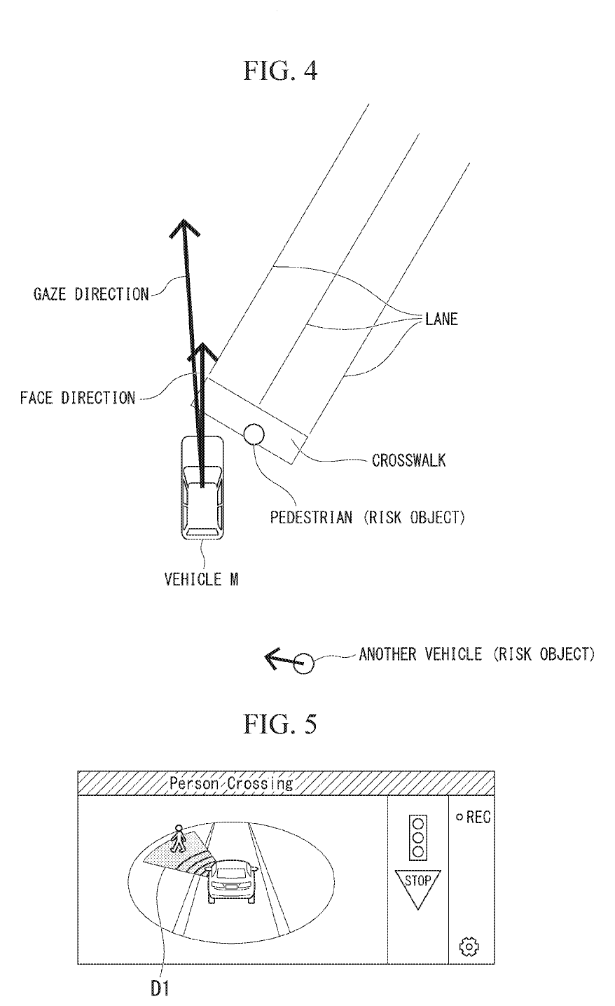

In addition to the face, the risk objects, the gaze, the face information, and the motions described above, the detector 30 may be configured to detect lanes, crosswalks, and the like. FIG. 4 is a diagram showing an example of detection information detected by the detector 30. In the example of FIG. 4, a pedestrian, another vehicle, lanes, and a crosswalk detected by the detector 30 are shown with the vehicle M, the gaze direction, and the face direction as references. The pedestrian and the other vehicle are examples of traffic participants (objects) that can be the risk objects. The detection information may be information in which the traffic participants (objects) that can be the risk objects detected by the detector 30 are shown with the vehicle M, a direction of the vehicle M, and/or a traveling direction of the vehicle M as the references, instead of the vehicle M, the gaze direction, and the face direction.

When the face is detected in the driver images, the oversight determiner 42 determines the presence or absence of an oversight of the driver on the risk object on the basis of the risk position and/or the risk presence direction, the gaze, and the face information. The “risk position” and the “risk presence direction” are each examples of “information relating to a position of a risk object.” The gaze and the face information are examples of "information relating to a driver image.”

For example, reference information (not shown) indicating a relationship between the direction of the driver’s eyes (gaze) and/or the face direction in the driver images and their directions relative to the traveling direction of the vehicle M may be stored in the storage 70 in advance. The oversight determiner 42 may refer to this reference information to determine whether or not the gaze direction and/or the face direction coincides with the risk presence direction. If the gaze direction and/or the face direction coincides with the risk presence direction, the oversight determiner 42 may determine that the driver is visually recognizing the risk object. The “case in which the gaze direction and/or the face direction coincides with the risk presence direction” may be, for example, a case in which the risk position is located on a straight line aligned with the gaze direction and/or the face direction. Alternatively, the "case in which the gaze direction and/or the face direction coincides with the risk presence direction” may be a case in which the risk position is located in a conical region that has its apex at a position of the gaze (eyeballs) and/or the face, its central axis is directed in the gaze direction and/or the face direction, and its side surface expands toward the front. If the gaze direction and/or the face direction does not match the location of the risk object, the oversight determiner 42 may determine that the driver is not viewing the risk object.

If a state in which the driver does not visually recognize the risk object is continued for a predetermined period of time or longer, the oversight determiner 42 may determine that there is an oversight of the driver on the risk object. If the driver visually recognizes the risk object, or if the state in which the driver does not visually recognize the risk object is resolved before the predetermined period of time has elapsed, the oversight determiner 42 may determine that there is no oversight of the driver on the risk object. However, the method for determining an oversight executed by the oversight determiner 42 is not limited to the above and can be changed as appropriate.

The oversight determiner 42 generates oversight determination information on the basis of the above determination results. The oversight determination information includes, for example, the presence or absence of the above-mentioned oversight and the risk presence direction.

The warning controller 52 causes the first terminal device T1 (warning part 82) to output warnings in different modes depending on whether or not the driver's face is detected. If the driver’s face is not detected, the warning controller 52 causes the first terminal device T1 (warning part 82) to output a first mode warning. If the driver’s face is detected, the warning controller 52 causes the first terminal device T1 (warning part 82) to output a second mode warning, different from the first mode. For example, the first mode warning and the second mode warning may use different warning techniques, or if a degree of warning changes on the basis of a risk position, duration of warning, or the like, may have different criteria for change.

### First Mode Warning

If the driver’s face is not detected, the warning controller 52 causes the first terminal device T1 (warning part 82) to output the first mode warning depending on whether or not the risk object is detected. The warning controller 52 causes the first terminal device T1 (warning part 82) to output the first mode warning if the risk object is detected, and does not cause the first terminal device T1 (warning part 82) to output the first mode warning if no risk object is detected.

The warning controller 52 may cause the first terminal device T1 (warning part 82) to output the first mode warning depending on the presence or absence of approaching risk objects and the number of detected risk objects. For example, the warning controller 52 may cause the first terminal device T1 (warning part 82) to output the first mode warning if the approach of a risk object is detected, and may not cause the first terminal device T1 (warning part 82) to output the first mode warning if the approach of a risk object is not detected. The warning controller 52 may cause the first terminal device T1 (warning part 82) to output the first mode warning if a plurality of risk objects are detected, and may not cause the first terminal device T1 (warning part 82) to output the first mode warning if a plurality of risk objects are not detected (no risk object is detected or one risk object is detected). By having the first mode warning output in accordance with the presence or absence of approaching risk objects and the number of detected risk objects, the warning can be output in situations in which it is more required to warn the driver. For example, one example of a case in which the driver’s face is not detected is when the driver leans forward to check his or her surroundings. In this case, it is inferred that the driver is checking surrounding conditions more carefully than during normal driving, and thus by issuing the warning only in the situations in which it is more required to warn the driver, it is possible to increase the driver’s acceptability for the warning.

For example, the warning controller 52 transmits first warning information to the first terminal device T1 via the communicator 60. The first warning information includes, for example, information indicating necessity for warning and the number of risk objects. For example, if a risk object is detected, the warning controller 52 generates the first warning information that includes information indicating “warning is required.” For example, if no risk object is detected, the warning controller 52 generates the first warning information including information indicating “no warning is required.” The first terminal device T1 outputs the first mode warning on the basis of the first warning information.

The first mode warning is, for example, a warning that includes a warning by display and a warning by sound. The first mode warning is a warning with more warning methods or a higher degree of warning than the second mode warning described below. FIG. 5 is a diagram showing an example of the first mode warning by display performed by the first terminal device T1 (warning part 82). The example of FIG. 5 shows the content in which the first terminal device T1 can recognize the risk presence direction (D1 in the figure). If a risk object is detected (that is, if the first warning information includes information indicating “warning is required,”) the first terminal device T1 performs a display indicating the risk presence direction and emits a warning sound from the speaker, thereby performing the first mode warning. The first terminal device T1 may increase the degree of warning by display as a distance between the risk object and the vehicle M decreases. “Increasing a degree of warning by display” may mean, for example, displaying the risk presence direction in an emphasized manner. The emphasized manner may be, for example, a mode in which the driver can be more likely to visually recognize the risk presence direction, such as emphasized by color, or emphasized by blinking or lighting an icon, or the like. The first terminal device T1 may increase the degree of warning by warning sound as the distance between the risk object and the vehicle M decreases. “Increasing a degree of warning by sound” may mean, for example, increasing a volume or changing a type of warning sound. In addition to the above, the first terminal device T1 may provide the first mode warning by emitting light.

In addition to the display and sound warnings performed by the first terminal device T1 described above, the first mode warning may be a warning by vibration of a steering wheel or driver’s seat of the vehicle M. Specifically, the information processing device 2 transmits the first warning information to the vehicle M via the communicator 60. On the basis of the first warning information, the vehicle M may output a warning to warn the driver by vibrating the steering wheel or driver’s seat of the vehicle M. In this case, the vehicle M is an example of the warning part 82. As long as it is possible to warn the driver, a specific method of the first mode warning can be changed as appropriate.

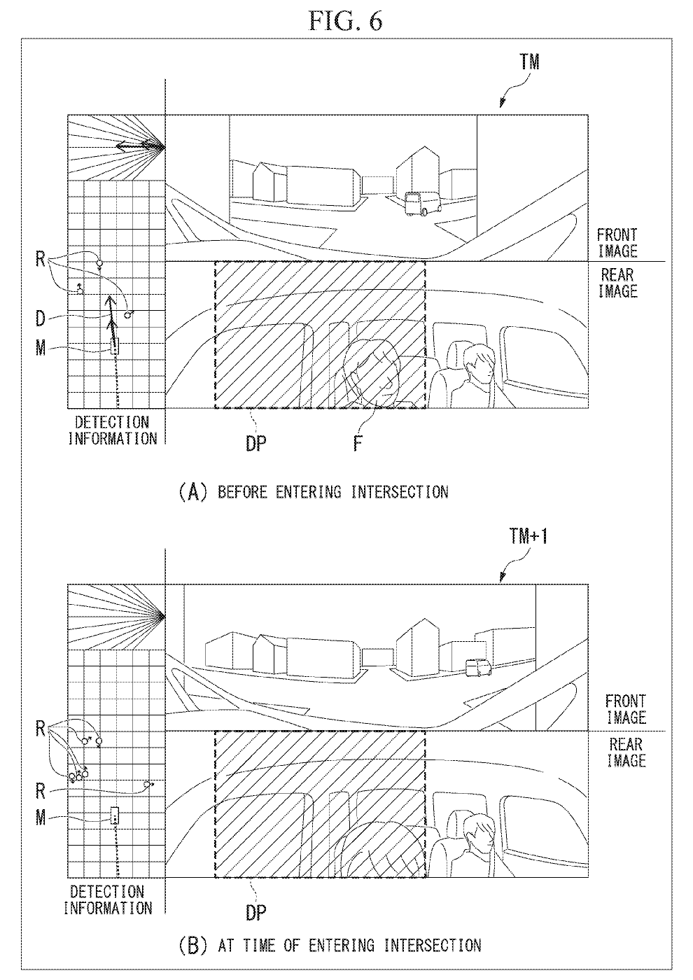

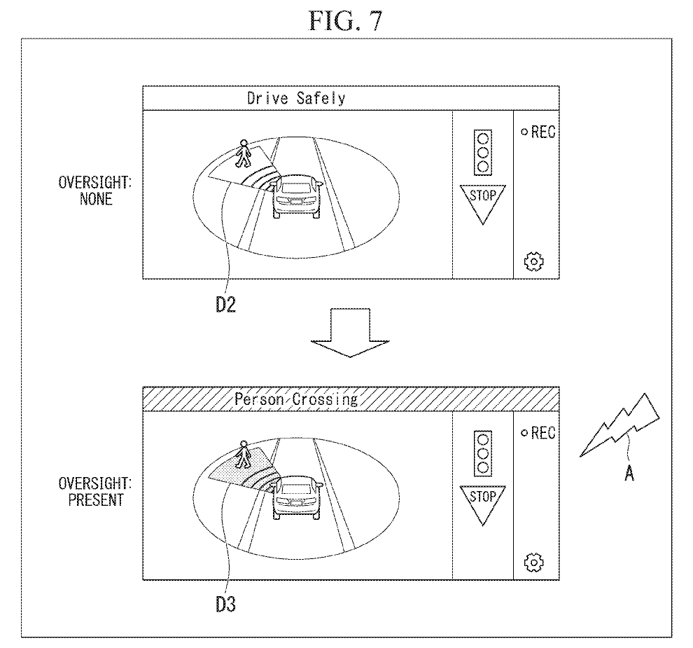

FIG. 6 is a diagram showing an example of a situation to which the process of the embodiment can be applied. FIG. 6 shows front images, rear images, and detection information in a situation such as entering an intersection with poor visibility. The rear images includes driver images DP. At time TM, which is a situation (A) before entering the intersection, the driver image DP includes a face F. That is, the face detector 32 detects the driver’s face. The detection information shows a plurality of risk objects R, the vehicle M, and a face direction D. At time TM+1, which is a situation (B) at the time of entering the intersection, the driver enters the intersection with poor visibility, and thus he or she leans forward from the driver’s seat to check for safety. In this case, the driver image DP does not include the face F. The motion detector 35 detects the driver’s forward leaning motion on the basis of a contour of the driver’s head detected from the driver images DP respectively captured at time TM and time TM+1, which moves from above to below in the rear images with the passage of time. That is, since the driver’s face is not included in the driver images DP and the driver’s forward leaning motion is detected, the face detector 32 determines that the driver’s face is not detected at time TM+1. The detection information shows the plurality of risk objects R and the vehicle M. At time TM+1, the driver’s face is not detected and the plurality of risk objects are detected, and thus the warning controller 52 transmits the first warning information including “warning is required" to the first terminal device T1. The first terminal device T1 outputs a warning including display and sound on the basis of the first warning information.

In the above example, a case in which the driver’s face is not included in the driver image DP due to the driver’s forward leaning motion has been described, but the same process may be performed in a case in which the driver’s face is not included in the driver image DP due to a driver’s motion other than the forward leaning motion. For example, the same process may be performed in a case in which the driver’s face is not included in the driver image DP because the driver is checking blind spots or covering the face with his or her hand to block the sunlight. If the driver is checking blind spots, the driver turns left and right to check the blind spots, and thus the face F is not included in the driver images DP. In this case, the motion detector 35 detects the driver’s turning around motion on the basis of positions of the driver’s facial parts detected from the driver images DP, which move left or right with the passage of time. For that reason, as described above, the face detector 32 determines that the driver’s face is not detected, and the warning controller 52 transmits the first warning information including “warning is required” to the first terminal device T1. If the driver covers the face with his or her hand to block the sunlight, the face is covered by the hand, and thus the face F is not included in the driver images DP. In this case, the motion detector 35 detects the motion of covering the face with the hand on the basis of the driver’s hand detected from the driver images DP, which is located at a position at which the driver’s face is located. For that reason, as described above, the face detector 32 determines that the driver’s face is not detected, and the warning controller 52 transmits the first warning information including “warning is required” to the first terminal device T1.

### Second Mode Warning

If the face is detected in the driver images, the warning controller 52 causes the first terminal device T1 (warning part 82) to output the second mode warning on the basis of the oversight determination information. For example, the warning controller 52 transmits second warning information to the first terminal device T1 via the communicator 60. The second warning information includes, for example, information indicating necessity for warning and the risk presence direction. For example, if the oversight determination information includes information indicating “there is an oversight,” the warning controller 52 generates the second warning information including information indicating "warning is required.” For example, if the oversight determination information includes information indicating “no oversight,” the warning controller 52 generates the second warning information including information indicating “no warning is required.” The first terminal device T1 outputs the second mode warning on the basis of the second warning information.

FIG. 7 is a diagram showing an example of the second mode warning performed by the first terminal device T1 (warning part 82). In the example of FIG. 7, the first terminal device T1 shows the content in which the risk presence directions (D2 and D3 in the figure) is recognizable. In addition, the first terminal device T1 performs the second mode warning by varying a display mode for the risk presence direction between a case in which there is an oversight on the risk object (that is, a case in which the warning information includes the information indicating “warning is required”) and a case in which there is no oversight on the risk object (that is, a case in which the warning information includes the information indicating “no warning is required”). Specifically, when there is an oversight on the risk, the risk presence direction is displayed in a more emphasized manner than when there is no oversight on the risk object. The emphasized manner may be, for example, a mode in which the driver can more easily visually recognize the risk presence direction, such as emphasized by color, or emphasized by blinking or lighting an icon, or the like. The second mode warning may vary the degree of warning depending on a relative speed of the risk object with respect to the vehicle M. For example, as the relative speed of the risk object with respect to the vehicle M is faster, the risk presence direction may be displayed in a more emphasized manner. The relative speed of the risk object with respect to the vehicle M may be calculated, for example, by the processor 40 analyzing changes over time in the risk position detected by the risk detector 31. In addition to or instead of the above, the first terminal device T1 may perform the second mode warning by issuing sound from a speaker, emitting light, or the like (A in the figure). A specific method of the second mode warning can be changed as appropriate, as long as it is recognizable by the driver.

For example, the second mode warning may be a warning with a higher degree of warning when there is an oversight on the risk object that when there is no oversight on the risk object. The degree of warning may be indicated, for example, by the intensity of warning, the number of types of warning, or the like. The warning controller 52 may increase the degree of warning, for example, by outputting a warning by display if there is no oversight on the risk object, and outputting a warning by sound or light in addition to the warning with display if there is an oversight on the risk object.

The first mode warning or the second mode warning performed by the first terminal device T1 (warning part 82) may be performed, for example, at a timing while the vehicle M is being driven by the driver (that is, in real time). Examples of the “timing while the vehicle M is driven by the driver” include a timing while the vehicle M is traveling, a timing while the vehicle M is temporarily stopped, or the like. For example, transmission of the first mode warning or the second mode warning performed by the warning controller 52 may be performed at the above timing. Alternatively, the transmission of the first warning information or the second warning information performed by the warning controller 52 may be performed at any timing, and the first terminal device T1 (warning part 82) may control the timing of the warning so that the first mode warning or the second mode warning is performed at the above timing.

### Process Flow

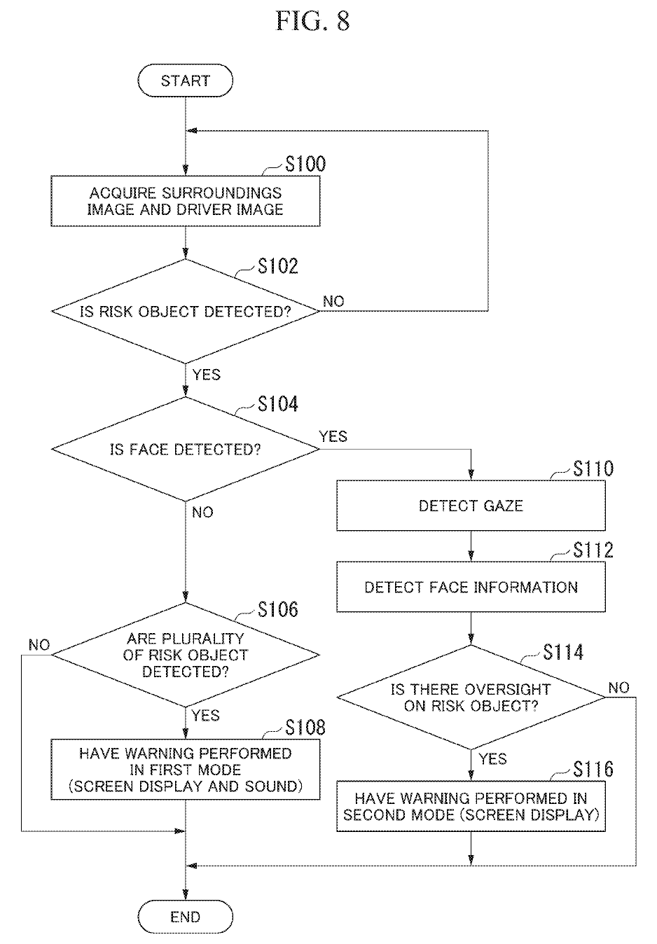

FIG. 8 is a flowchart showing an example of a process flow performed by the information processing device 2. The process of the flowchart shown in FIG. 8 is executed repeatedly (periodically) while the vehicle M is being driven.

First, the acquirer 20 acquires the surroundings image and the driver image (step S100). If no risk object is detected (step S102; NO), the process of step S100 is performed again. If a risk object is detected (step S102; YES), the face detector 32 determines whether or not the driver’s face is detected (step S104). If the driver’s face is not detected (step S104; NO), the warning controller 52 determines whether or not a plurality of risk objects are detected by the risk detector 31 (step S106). If the plurality of risk objects are detected (step S106; YES), the warning controller 52 causes the warning part 82 to perform the warning in the first mode (step S108). After the process of step S108, or if the plurality of risk objects have not been detected (step S106; NO), the information processing device 2 ends the process of the flowchart shown in FIG. 8.

If the driver’s face is detected (step S104; YES), the gaze detector 33 detects the driver’s gaze (step S110). Next, the face direction detector 34 detects the face information (step S112). Next, the oversight determiner 42 determines whether or not there is an oversight on the risk object on the basis of the information relating to the position of the risk object and the information relating to the driver image (step S114). That is, the oversight determiner 42 determines whether or not there is an oversight on the risk object on the basis of the risk position and/or risk presence direction, the gaze, and the face information. If there is an oversight on the risk object (step S114; YES), the warning controller 52 causes the warning part 82 to perform the warning in the second mode (step S116). After the process of step S116, or if there is no oversight on the risk object (step S114; NO), the information processing device 2 ends the process of the flowchart shown in FIG. 8.

The order of the above processes may be changed, or some of the above processes may be deleted or modified. For example, the process of step S110 may be performed after the process of step S112. For example, the process of step S108 may be performed after completion of the process of step S104 without performing the process of step S106, or instead of step S106, it may be determined whether or not the approach of the risk object has been detected. In this case, if the approach of the risk object is detected, the process proceeds to step S108, and if the approach of the risk object is not detected, the process shown in the flowchart ends.

According to the embodiment described above, the information processing device 2 includes the acquirer that acquires the surroundings image of the vehicle and the driver image including the driver of the vehicle, the risk detector that detects the risk object present around the vehicle on the basis of the surroundings image, the face detector that detects the driver’s face on the basis of the driver image, and the warning controller that causes the warning part to perform the warning in different modes depending on whether or not the driver’s face is detected if the risk object is detected. Thus, the appropriate warning can be performed. For example, when a driver leans forward to check for safety at an intersection with poor visibility, the driver's face may not be included in an image captured by the information processing device 2 since the driver takes a forward leaning posture. When the driver takes the forward leaning posture, a screen of the first terminal device T1 may be outside the gaze, making it difficult to visually observe the display on the first terminal device T1. For that reason, when the driver’s face is not detected (when the driver’s face is not included in the driver image), the warning part 82 is caused to output the first mode warning including both display and sound, so that it is possible to appropriately warn the driver as compared to when only a display warning is output.

### Modified Examples

The technical scope of the present invention is not limited to the above-described embodiment, and various modifications can be applied without departing from the spirit of the present invention.

For example, the driving monitoring device 1 (information processing device 2) may perform another warning process (hereinafter referred to as an auxiliary warning process) in addition to (or instead of) the risk object warning process described above. The auxiliary warning process may be, for example, a collision warning process or the like of detecting the possibility of a risk object colliding with the vehicle M on the basis of a position and a relative speed of the risk object with respect to the vehicle M, and causes the warning part 82 to perform a warning. In the collision warning process, the relative speed of the risk object with respect to the vehicle M may be calculated, for example, by having the processor 40 analyze changes over time in the risk position detected by the risk detector 31. If the possibility of the risk object colliding with the vehicle M is detected by the processor 40, the warning controller 52 may cause the warning part 82 to perform the warning. Similarly to the risk object warning process, the auxiliary warning process may be performed at a timing while the vehicle M is being driven by the driver (that is, in real time). In the configuration in which the driving monitoring device 1 (information processing device 2) performs the auxiliary warning process, the warning performed by the warning part 82 based on the oversight determination result determined by the oversight determiner 42 may not be performed. In this case, the oversight determination performed by the oversight determiner 42 is also executed for the purpose of the abnormality notification process described above.

In the above-described embodiment, the driving monitoring device 1 (information processing device 2) and the first terminal device T1 are configured as separate devices, but they may be configured as an integrated device. For example, the driving monitoring device 1 may be equipped with all of the functions of the imaging part 10, the acquirer 20, the detector 30, the processor 40, the controller 50, the storage 70, and the warning part 82. Alternatively, the first terminal device T1 or the vehicle M may be equipped with all of these functions. In the above-described embodiment, the driving monitoring device 1 (information processing device 2) has been described as a device that is not connected to the in-vehicle network of the vehicle M, but the driving monitoring device 1 (information processing device 2) may be a device connected to the in-vehicle network of the vehicle M. When the driving monitoring device 1 is connected to the in-vehicle network of the vehicle M, the information processing device 2 may acquire information relating to the vehicle M and the driver via the in-vehicle network. The Information relating to the vehicle M and the driver is, for example, information relating to positions and the number of risk objects, driver images, and surroundings images. The information processing device 2 may perform processes performed by the detector 30, the processor 40, the controller 50, the storage 70, or the warning part 82 on the basis of the information acquired via the in-vehicle network. For example, the warning controller 52 may acquire the positions and the number of risk objects via the in-vehicle network instead of the risk detector 31, and output the first mode warning on the basis of the information.

The driving monitoring device 1 may be implemented using a plurality of information processing devices. For example, the functions included in the information processing device 2 may be implemented in the first terminal device T1 or the vehicle M (for example, ECUs). Alternatively, the driving monitoring device 1 may be implemented using a device such as the cloud. For example, in the driving monitoring device 1, the detector 30, the processor 40 and the controller 50, and the storage 70 may be implemented in different information processing devices. For example, the storage 70 may be distributed and implemented in a plurality of information processing devices.

The embodiment and the modified examples described above can be expressed as follow.

An information processing device including:

a storage medium configured to store computer-readable instructions; and

a processor connected to the storage medium,

the processor executing the computer-readable instructions to:

acquire a surroundings image of a vehicle and a driver image including a driver of the vehicle;

detect a risk object present around the vehicle on the basis of the surroundings image;

detect the driver’s face on the basis of the driver image; and

cause a warning part to perform a warning in different modes depending on whether or not the driver’s face is detected if the risk object is detected.

The constituent elements in the above-described embodiment can be replaced with known constituent elements within the range not departing from the spirit of the present invention, and the embodiment and the modified examples described above may be combined as appropriate.

What is claimed is:

1. An information processing device comprising:
a storage medium configured to store computer-readable instructions; and
one or more processors connected to the storage medium,
the one or more processors executing the computer-readable instructions to:
acquire a surroundings image of a vehicle and a driver image including a driver of the vehicle;
detect a risk object present around the vehicle on the basis of the surroundings image;
detect the driver’s face on the basis of the driver image; and
cause a warning part to perform a warning in different modes depending on whether or not the driver’s face is detected
when the risk object is detected.

2. The information processing device according to claim 1,
the one or more processors executing the computer-readable instructions to:
acquire the surroundings images in chronological order;
detect approach of the risk object to the vehicle on the basis of a plurality of the surroundings images; and
cause the warning part to perform the warning in a first mode
when the approach of the risk object is detected and the driver’s face is not detected.

3. The information processing device according to claim 1,
the one or more processors executing the computer-readable instructions to determine that the driver’s face is not detected
when the driver’s face is not included in the driver image.

4. The information processing device according to claim 1,
the one or more processors executing the computer-readable instructions to:
acquire the driver images in chronological order;
detect the driver's motion on the basis of a plurality of the driver images; and
determine that the driver’s face is not detected
when the driver’s motion of moving from a first position to a second position is detected, the first position being detectable of the driver’s face, the second position being non detectable of the driver’s face , and
when the driver’s face is not included in the driver images.

5. The information processing device according to claim 4,
the one or more processors executing the computer-readable instructions to determine that the driver’s face is not detected
when the driver’s motion is a forward leaning motion of the driver and the driver’s face is not included in the driver images.

6. The information processing device according to claim 4,
the one or more processors executing the computer-readable instructions to determine that the driver’s face is not detected
when the driver’s motion is a motion of the driver turning left or right and the driver’s face is not included in the driver images,

7. The information processing device according to claim 4,
the one or more processors executing the computer-readable instructions to determine that the driver’s face is not detected
when the driver’s motion is a motion of covering the driver’s face with part of the driver’s body and the driver’s face is not included in the driver images.

8. The information processing device according to claim 2,
the one or more processors executing the computer-readable instructions to cause the warning part to perform the warning in a second mode different from the first mode
when the risk object is detected and the driver’s face is detected.

9. The information processing device according to claim 8,
the one or more processors executing the computer-readable instructions to:
determine whether or not there is an oversight on the risk object on the basis of information relating to the risk object and information relating to the driver image
when the driver’s face is detected; and
change a degree of warning performed by the warning part depending on whether or not there is an oversight on the risk object.

10. The information processing device according to claim 9,
the one or more processors executing the computer-readable instructions to cause the warning part not to perform the warning
when it is determined that there is no oversight on the risk object.

11. The information processing device according to claim 2, wherein the first mode warning includes, at least, a warning by display and a warning by sound.

12. The information processing device according to claim 11,
the one or more processors executing the computer-readable instructions to cause the warning part to perform the warning in the first mode
when the driver’s face is not detected and a plurality of the risk object are detected.

13. The information processing device according to claim 9, wherein the second mode warning is at least a warning by display.

14. An information processing method causing a computer to execute:
acquiring a surroundings image of a vehicle and a driver image including a driver of the vehicle;
detecting a risk object present around the vehicle on the basis of the surroundings image;
detecting the driver’s face on the basis of the driver image; and
causing a warning part to perform a warning in different modes depending on whether or not the driver’s face is detected
when the risk object is detected.

15. A non-transitory storage medium storing a program causing a computer to execute:
acquiring a surroundings image of a vehicle and a driver image including a driver of the vehicle;
detecting a risk object present around the vehicle on the basis of the surroundings image;
detecting the driver’s face on the basis of the driver image; and
causing a warning part to perform a warning in different modes depending on whether or not the driver’s face is detected
when the risk object is detected.
